(19) United States
(12) Patent Application Publication
(10) Pub. No.: US 2006/0161781 A1
(43) Pub. Date: Jul. 20, 2006

(54) Automated notary acknowledgement

(76) Inventors: Robert Rice, Brady, TX (US); Jason Streit, Vernon, TX (US)

Correspondence Address: CARSTENS & CAHOON, LLP, P O BOX 802334, DALLAS, TX, 75380, US

(21) Appl. No.: 11/039,232

(22) Filed: Jan. 18, 2005

(51) Int. Cl. H04L 9/00

(52) U.S. Cl. 713/176

(57) ABSTRACT

A method, program, and system for notarizing and verifying documents via a distributed computer network are provided by the present invention. The invention includes creating an electronic version of the document on a client computer in the network and inserting a pre-written acknowledgment template into said electronic document, wherein the acknowledgment template complies with local legal formalities for a certified party that has authority by law to verify and authenticate the signer of a document. The document is then encrypted and stored on a secure server in the computer network, wherein the stored electronic document may be retrieved by any client in the computer network. The signing party is then notified of the electronic document's identity and directed to the location of a certified notary within the signing party's geographic vicinity. The signing party visits the notary and retrieves the electronic document on the notary's client computer. The signing party then electronically signs the document using an electronic writing pad. The notary verifies the transaction and affixes his electronic signature to the document and also affixes an electronic image of his notary seal to the document and saves it on the server. Any certified notary in the network may then retrieve the signed, notarized document.

### BACKGROUND OF THE INVENTION

1. Technical Field

The present invention relates to electronic document processing and more specifically to a method for collecting, verifying, and notarizing documents through a decentralized system, while satisfying federal and local legal formalities.

2. Description of Related Art

Many legal documents require notarization to verify their authenticity. While the general concept of notarization crosses legal jurisdictions, each jurisdiction has its own unique, local requirements for proper notarization. These local requirements include qualifications to become a notary as well as formalities regarding the proper language, seal or stamp used for the notarization.

A problem often encountered with notarization of legal documents is geographic distance between parties to a document. In such a scenario, the documents must be physically sent to one party, who signs them and has them notarized by a local notary in accordance with local legal requirements. The documents are then usually returned to the sending party (i.e. attorney), who then sends the documents to a second party, who similarly has them properly notarized, etc. This process is cumbersome and time consuming and also runs the risk of losing documents while sending them back and forth.

In response to this problem a method and system has been developed for collecting properly notarized documents electronically through a geographically decentralized network of notaries. However, because of the varying legal formalities for notary certificates between jurisdictions, the creation of a legal document may require the creator to write several versions of the certificate from scratch. Not only is this time consuming, especially for high volume practices, but it also runs the risk of mistakes regarding local formalities.

Therefore, it would be desirable to have a method for creating notary certificate templates that can be inserted into legal documents for electronic notarization through a geographically decentralized network of notaries.

### SUMMARY OF THE INVENTION

The present invention provides a method, program, and system for notarizing and verifying documents via a distributed computer network. The invention includes creating an electronic version of the document on a client computer in the network and inserting a prewritten acknowledgment template into said electronic document, wherein the acknowledgment template complies with local legal formalities for a certified party that has authority by law to verify and authenticate the signer of a document. The document is then encrypted and stored on a secure server in the computer network, wherein the stored electronic document may be retrieved by any client in the computer network. The signing party is then notified of the electronic document's identity and directed to the location of a certified notary within the signing party's geographic vicinity. The signing party visits the notary and retrieves the electronic document on the notary's client computer. In a preferred embodiment of the present invention, when the document is retrieved by the notary, the notary's name and commission information is automatically filled into the acknowledgment, and the notary is prompted to manually insert any necessary information. The signing party then electronically signs the document using an electronic writing pad. The notary verifies the transaction and affixes his electronic signature to the document and also affixes an electronic image of his notary seal to the document and saves it on the server. Any certified notary in the network may then retrieve the signed, notarized document.

### BRIEF DESCRIPTION OF THE DRAWINGS

The novel features believed characteristic of the invention are set forth in the appended claims. The invention itself, however, as well as a preferred mode of use, further objectives and advantages thereof, will best be understood by reference to the following detailed description of an illustrative embodiment when read in conjunction with the accompanying drawings, wherein:

FIG. 1 is a pictorial representation of a network of data processing systems in which the present invention may be implemented;

FIG. 2, a block diagram of a data processing system that may be implemented as a server is depicted in accordance with a preferred embodiment of the present invention;

FIG. 3 is a block diagram illustrating a data processing system in which the present invention may be implemented;

FIG. 4 is a flowchart illustrating the process of notarizing a document electronically in accordance with the present invention;

FIG. 5 is a flowchart illustrating an alternate notarization process in which a non-client individual wants to send a document for signing that requires notarization or verification;

FIG. 6 is a flowchart illustrating the process of creating a notary certificate in more detail;

FIG. 7A shows a graphical user interface of a certificate template file in accordance with a preferred embodiment of the present invention;

FIG. 7B shows a selection of jurisdiction-specific certificate templates in the template file;

FIG. 7C shows a generic corporate acknowledgment that has been retrieved from the template file;

FIG. 7D shows the certificate with notary data base information automatically filled in;

FIG. 7E shows an input field that allows the notary to enter prompted information; and

FIG. 7F shows a completed notary certification with the notary's seal and signature affixed.

### DETAILED DESCRIPTION OF THE INVENTION

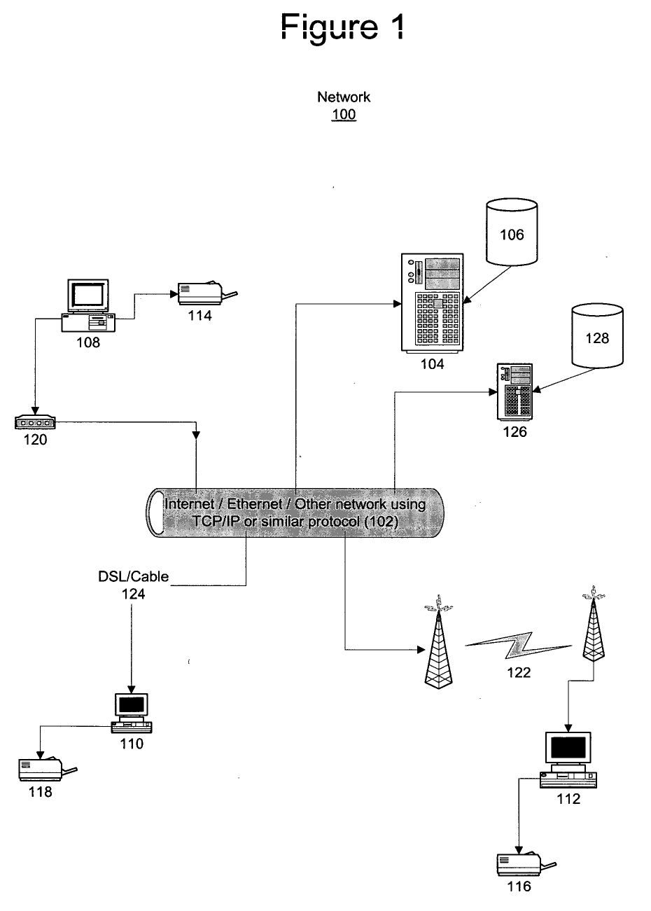

With reference now to the figures, FIG. 1 is a pictorial representation of a network of data processing systems in which the present invention may be implemented. Network data processing system 100 is a network of computers in which the present invention may be implemented. Network data processing system 100 contains a network 102, which is the medium used to provide communications links between various devices and computers connected together within network data processing system 100. Network 102 may include connections, such as wire, wireless communication links, or fiber optic cables.

In the depicted example, a server 104 is connected to network 102 along with storage unit 106. In addition, clients 108, 110, and 112 also are connected to network 102. These clients 108, 110, and 112 may be, for example, personal computers or network computers. In the depicted example, server 104 provides data, such as boot files, operating system images, and applications to clients 108-112. Network data processing system 100 might also contain a supplementary server 126 and additional data storage 128.

Clients 108, 110, and 112 are clients to server 104. Network data processing system 100 includes printers 114, 116, and 118, and may also include additional servers, clients, and other devices not shown. The means by which clients 108-112 connect to the network 102 may include conventional telephone landline 120, broadband Digital Service Line (DSL) or cable 124, or wireless communication network 122.

In the depicted example, network data processing system 100 is the Internet with network 102 representing a worldwide collection of networks and gateways that use the TCP/IP suite or similar protocols to communicate with one another. At the heart of the Internet is a backbone of high-speed data communication lines between major nodes or host computers, consisting of thousands of commercial, government, educational and other computer systems that route data and messages. Of course, network data processing system 100 also may be implemented as a number of different types of networks, such as for example, an intranet, a local area network (LAN), or a wide area network (WAN). FIG. 1 is intended as an example, and not as an architectural limitation for the present invention.

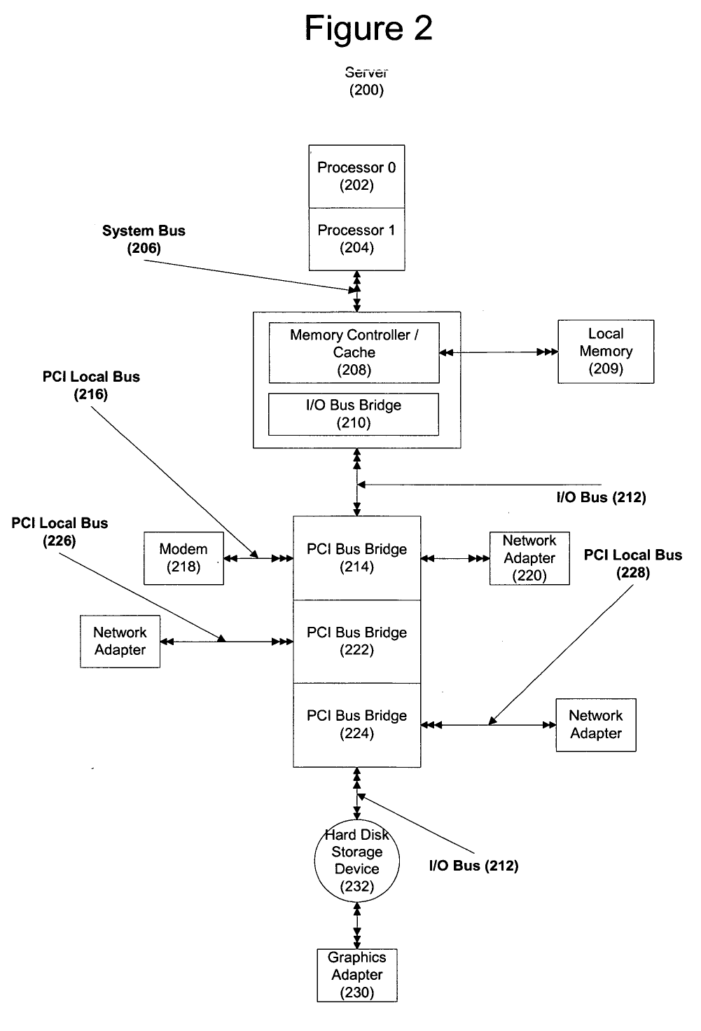

Referring to FIG. 2, a block diagram of a data processing system that may be implemented as a server, such as server 104 in FIG. 1, is depicted in accordance with a preferred embodiment of the present invention. Data processing system 200 may be a symmetric multiprocessor (SMP) system including a plurality of processors 202 and 204 connected to system bus 206. Alternatively, a single processor system may be employed. Also connected to system bus 206 is memory controller/cache 208, which provides an interface to local memory 209. I/O bus bridge 210 is connected to system bus 206 and provides an interface to I/O bus 212. Memory controller/cache 208 and I/O bus bridge 210 may be integrated as depicted.

Peripheral component interconnect (PCI) bus bridge 214 connected to I/O bus 212 provides an interface to PCI local bus 216. A number of modems may be connected to PCI bus 216. Typical PCI bus implementations will support four PCI expansion slots or add-in connectors. Communication links to network computers 108-112 in FIG. 1 may be provided through modem 218 and network adapter 220 connected to PCI local bus 216 through add-in boards.

Additional PCI bus bridges 222 and 224 provide interfaces for additional PCI buses 226 and 228, from which additional modems or network adapters may be supported. In this manner, data processing system 200 allows connections to multiple network computers. A memory-mapped graphics adapter 230 and hard disk 232 may also be connected to I/O bus 212 as depicted, either directly or indirectly.

Those of ordinary skill in the art will appreciate that the hardware depicted in FIG. 2 may vary. For example, other peripheral devices, such as optical disk drives and the like, also may be used in addition to or in place of the hardware depicted. The depicted example is not meant to imply architectural limitations with respect to the present invention.

The data processing system depicted in FIG. 2 may be, for example, an eServer pSeries system, a product of International Business Machines Corporation in Armonk, N.Y., running the Advanced Interactive Executive (AIX) or Linux operating systems.

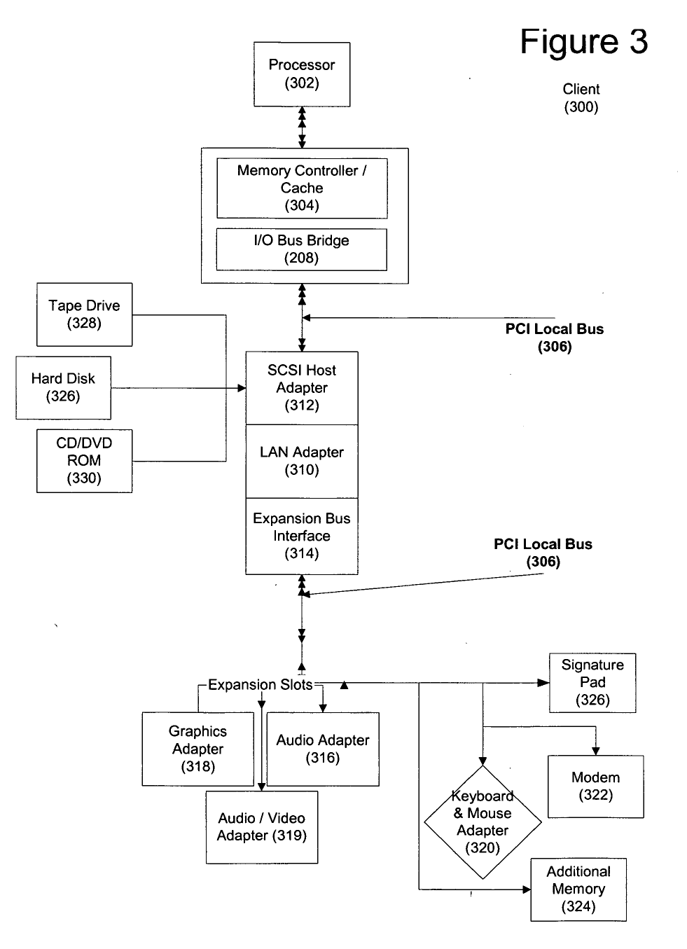

With reference now to FIG. 3, a block diagram illustrating a data processing system is depicted in which the present invention may be implemented. Data processing system 300 is an example of a client computer. Data processing system 300 employs a peripheral component interconnect (PCI) local bus architecture. Although the depicted example employs a PCI bus, other bus architectures such as Accelerated Graphics Port (AGP) and Industry Standard Architecture (ISA) may be used. Processor 302 and main memory 304 are connected to PCI local bus 306 through PCI bridge 308. PCI bridge 308 also may include an integrated memory controller and cache memory for processor 302. Additional connections to PCI local bus 306 may be made through direct component interconnection or through add-in boards. In the depicted example, local area network (LAN) adapter 310, SCSI host bus adapter 312, and expansion bus interface 314 are connected to PCI local bus 306 by direct component connection. In contrast, audio adapter 316, graphics adapter 318, and audio/video adapter 319 are connected to PCI local bus 306 by add-in boards inserted into expansion slots. Expansion bus interface 314 provides a connection for a keyboard and mouse adapter 320, modem 322, and additional memory 324. An electronic signature pad 326 and or biometric device or other authorization device is connected to the client computer 300 by common input interface.

Small computer system interface (SCSI) host bus adapter 312 provides a connection for hard disk drive 326, tape drive 328, and CD/DVD-ROM drive 330. Typical PCI local bus implementations will support three or four PCI expansion slots or add-in connectors.

An operating system runs on processor 302 and is used to coordinate and provide control of various components within data processing system 300 in FIG. 3. The operating system may be a commercially available operating system, such as Windows 2000, which is available from Microsoft Corporation. An object oriented programming system such as Java may run in conjunction with the operating system and provide calls to the operating system from Java programs or applications executing on data processing system 300. “Java” is a trademark of Sun Microsystems, Inc. Instructions for the operating system, the object-oriented operating system, and applications or programs are located on storage devices, such as hard disk drive 326, and may be loaded into main memory 304 for execution by processor 302.

Those of ordinary skill in the art will appreciate that the hardware in FIG. 3 may vary depending on the implementation. Other internal hardware or peripheral devices, such as flash ROM (or equivalent nonvolatile memory) or optical disk drives and the like, may be used in addition to or in place of the hardware depicted in FIG. 3. Also, the processes of the present invention may be applied to a multiprocessor data processing system.

As another example, data processing system 300 may be a stand-alone system configured to be bootable without relying on some type of network communication interface, whether or not data processing system 300 comprises some type of network communication interface. As a further example, data processing system 300 may be a Personal Digital Assistant (PDA) device, which is configured with ROM and/or flash ROM in order to provide non-volatile memory for storing operating system files and/or user-generated data.

The depicted example in FIG. 3 and the above-described examples are not meant to imply architectural limitations. For example, data processing system 300 also may be a notebook computer or hand-held computer in addition to taking the form of a PDA. Data processing system 300 also may be a kiosk or a Web appliance.

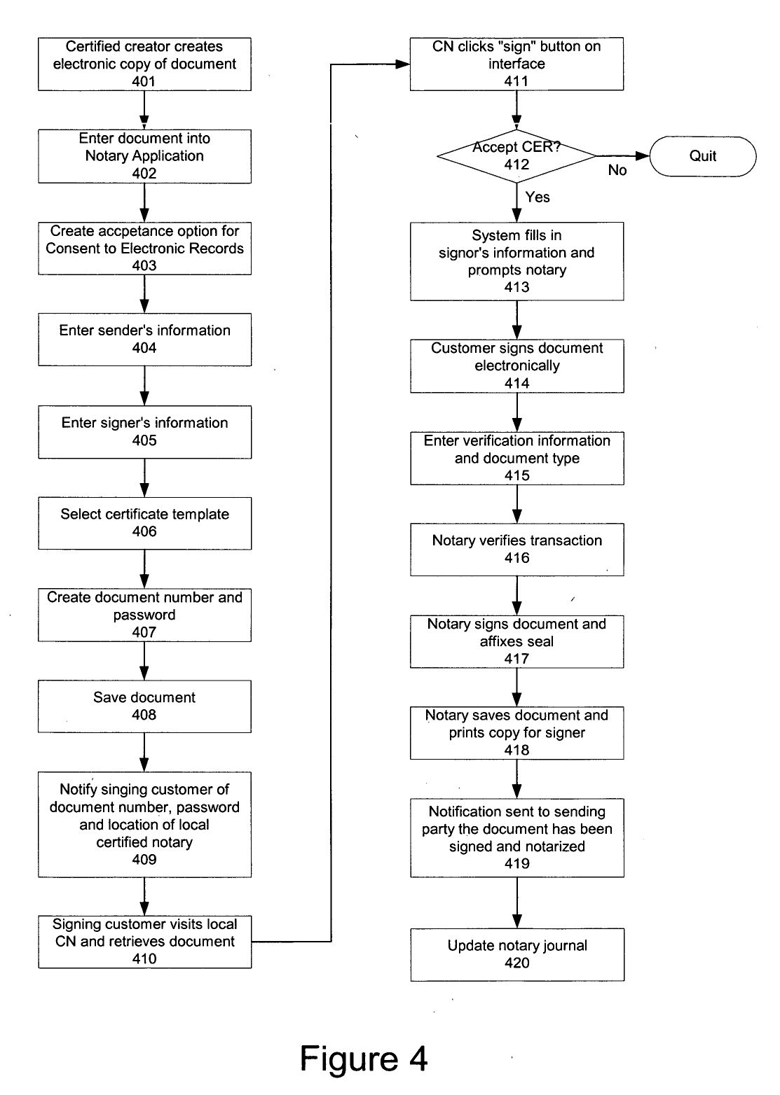

Referring to FIG. 4, a flowchart illustrating the process of notarizing a document electronically is depicted in accordance with the present invention. This process applies to professional clients of the Notary Service that routinely create legal documents requiring notarization and verification. Examples of such clients include law firms, title companies, banks, insurance companies, real estate companies, and justices of the peace.

The process begins when a Certified Creator (CC) creates a copy of a legal document within any application running in a Windows environment, e.g., MS Word, MS Excel, or Word Perfect (step 401). After the document is created, a Certified Notary (CN) or CC clicks to start the session and a Notary Application Creation Wizard enters the document into the Notary Application running on the CC's client computer, where it is converted and encrypted (step 402).

The Application then creates an acceptance option for the Consent to Electronic Records (CER) of the transaction (step 403). This acceptance option will be automatically saved and can be presented to the signer when the document is accessed for signature (described below).

The CC clicks on the Creation Wizard and enters the sender's information (step 404) and the signer's information into the document (step 405). The CC then selects a template for a notary certificate (step 406). The certificate is contained in a file with several versions of acknowledgments for different occasions and jurisdictions (explained in more detail below). The certificates contain the proper legal formalities for individual and corporate acknowledgments and define the coordinates within the document that are designated for the signature or initials of the customer signer, as well as for a notary's signature, seal, dates, and time. Steps 405 and 406 can be repeated for additional signers to the document. The Notary Application assigns a unique document number and the CC issues a unique password for the document in question and prints an invoice for the customer. (step 407). The creation of the document is now complete, and the document is saved in a data base on a server that can be accessed by any Certified Notary (CN) in the network (step 408).

The CC notifies the customer signer of the document number and password, as well as the location and contact information for the nearest CN in the signer's area (step 409).

The customer signer visits the CN in his or her area and provides the document number and password, which the CN uses to retrieve the document from the central data base after the CN has been authenticated and logged into the application (step 410). Once the document is pulled up and has been reviewed, and the Signing Customer or, the CN clicks a “sign” button (step 411), the Sign Wizard starts and the customer signer must decide whether to accept or reject the CER (Step 412).

If the signer rejects the CER, the Notary Application quits. If the signer accepts the CER, Notification is saved, and the system automatically fills in information from the data base concerning the notary and signer and prompts the notary for additional information (see below) (step 413). The signer reviews and signs the document electronically (step 414). The signature can be obtained using an electronic signature pad, similar to those used in retail credit card transactions. The CN then gathers verification information and document type and enters this information into the Notary Application (step 415).

The CN verifies and documents the transaction, i.e. identity of the customer signer, document type, type of notarization, acknowledgement, Jurat, oath, etc. (step 416) and signs the document and affixes the official notary seal, which is stored electronically by the Notary Application (step 417). The notary signature may either be added using an electronic signature pad or stored in the Notary Application on the CN's client. The Notary Application automatically enters the date and time of the transaction into designated coordinates. The CN saves the document and can print a copy of the document for the customer signer (step 418). The Application can also print an invoice.

An electronic notification (i.e. email) is sent back to the sender confirming that the document has been signed by the customer signer in question and properly notarized by the local CN (step 419). The document can then be retrieved by the sender CC or another CN should additional signatures be necessary. An electronic notary journal or register file is automatically generated and updated containing all the necessary information regarding the transaction (step 420). The journal may include information about the sender, sending customer, time, dates, type of document, fees, type of notarization, and signer's signature and verification information. All of this information is saved to the specific notary's journal data base with in the notary application. The notary can then recall the journal within the Notary Application at any time.

The notary network described above may also have differing levels of access for Certified Creators and Certified Notaries. For example, Certified Notaries (including consulates, court clerks, or anyone with legal authority to verify/notarize a document) may be allowed to both create and verify/notarize documents. However, Certified Creators (e.g., secretaries, paralegals, bank officers, etc.) may be allowed to create documents but have no authority to verify/notarize the documents.

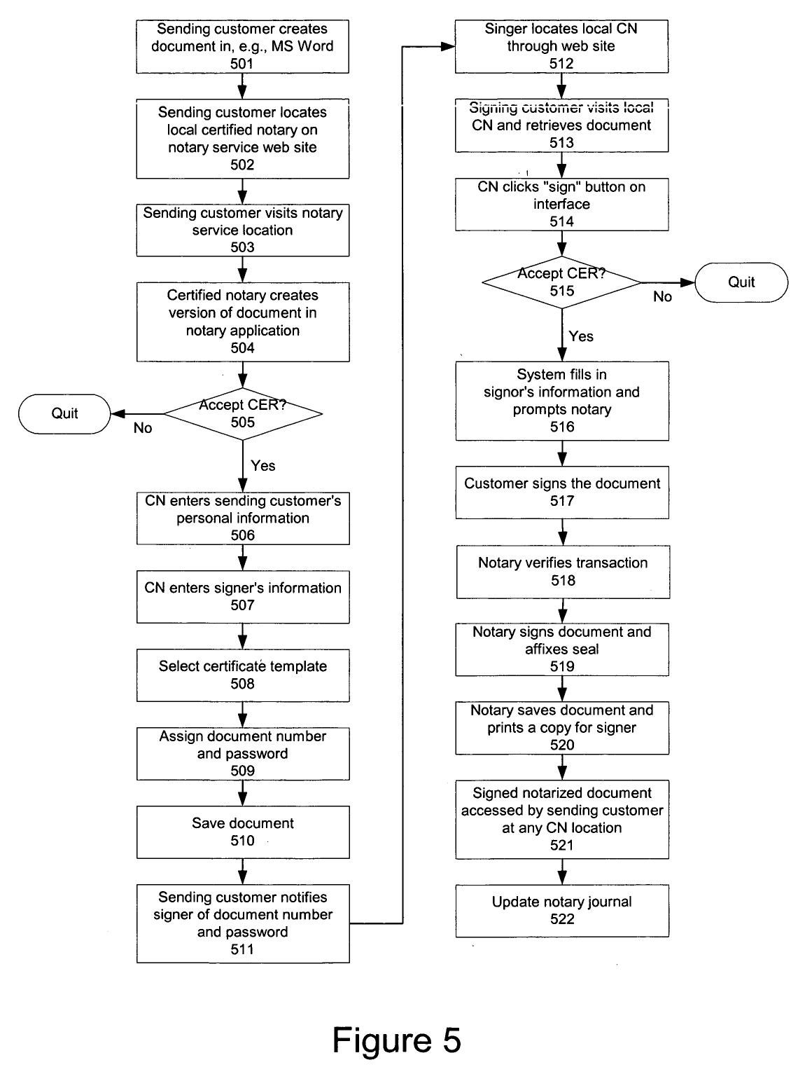

FIG. 5 is a flowchart illustrating an alternate notarization process in which a non-client individual wants to send a document for signing that requires notarization or verification. This process applies to individuals who occasionally need to send documents for signature and notarized and would access the Notary Service via walk-in service providers and retailers, e.g., copy centers, hotel business offices, package stores, banks, etc.

The process begins with the sending customer creating the document in a standard computer application, e.g., Word Perfect, MS Word, Excel, etc., and saves it to disk (step 501). The sending customer then visits the Notary Service web site and finds a CN in his area (step 502).

The Sending customer visits the CN and presents the disk containing the document, and the CN starts the session on the Notary Application (step 503). The CN opens a Create “wizard” to create a version of the document in the Notary Application (step 504). The sending customer then chooses to accept or reject the CER (step 505). If the customer rejects the acceptance, the session ends and the application quits.

If the customer accepts the CER, the process continues and CN enters the customer's personal information into the Notary Application (step 506) and the signing party's information (step 507) and then selects a template for the notary certificate (step 508). The Application assigns a document number and the CC or CN enters a unique password (which is provided to the sending customer) and prints the document and presents an invoice. (step 509). The document is now created and saved in the Notary Service data base on a server and may be accessed by a CN in the network (step 510).

At this point the sending customer can notify the signing customer about the document and provide the document number and password (step 511). The location of a local CN in the signing party's area can be obtained from the Notary Service web site by either the sending customer or signing party (step 512).

Similar to the process in FIG. 4, the signing customer visits a local CN and retrieves the document from the data base using the document number and password (step 513). Once the document is pulled up, the CN clicks a “sign” button (step 514), and the signing customer has to accept or reject the CER (Step 515).

The system automatically fills in information from the data base concerning the notary and signer and prompts the notary for additional information (see below) (step 516). The signing customer signs the document using an electronic signature pad as described above (step 517). The CN verifies and documents the transaction, i.e. identity of the customer signer, document type, type of notarization, acknowledgement, Jurat, oath, etc. (step 518) and signs the document and affixes the proper seal (step 519). The CN saves the document and prints a copy of the document for the signing customer (step 520) application prints an invoice for the customer signer. The sending customer may then retrieve the signed, notarized document at any CN or CC location (step 521). After the transaction is complete, a notary journal is updated, as explained above (step 522).

As stated above, the present invention can be implemented with different user classes with specific abilities, duties, and restrictions. These user types may include notaries, document creators, county clerks, state certification agents, etc. Examples of legal document to which the present invention may apply include contracts, affidavits, Apostilles, foreign consulate documentation, wills, codicils, etc. Users can be any certified or commissioned user that has domestic or foreign authority by law to verify or authenticate the signer of a document.

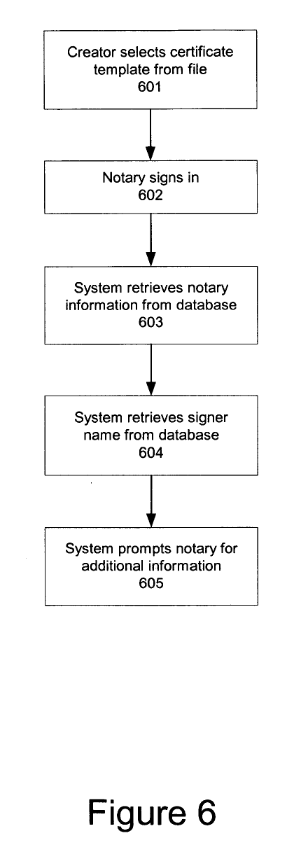

FIGS. 6 is a flowchart illustrating the creation of the notary certificate in more detail. During the creation of the legal document in question, the certified creator selects the appropriate acknowledgment from the template file (as described above) (step 601).

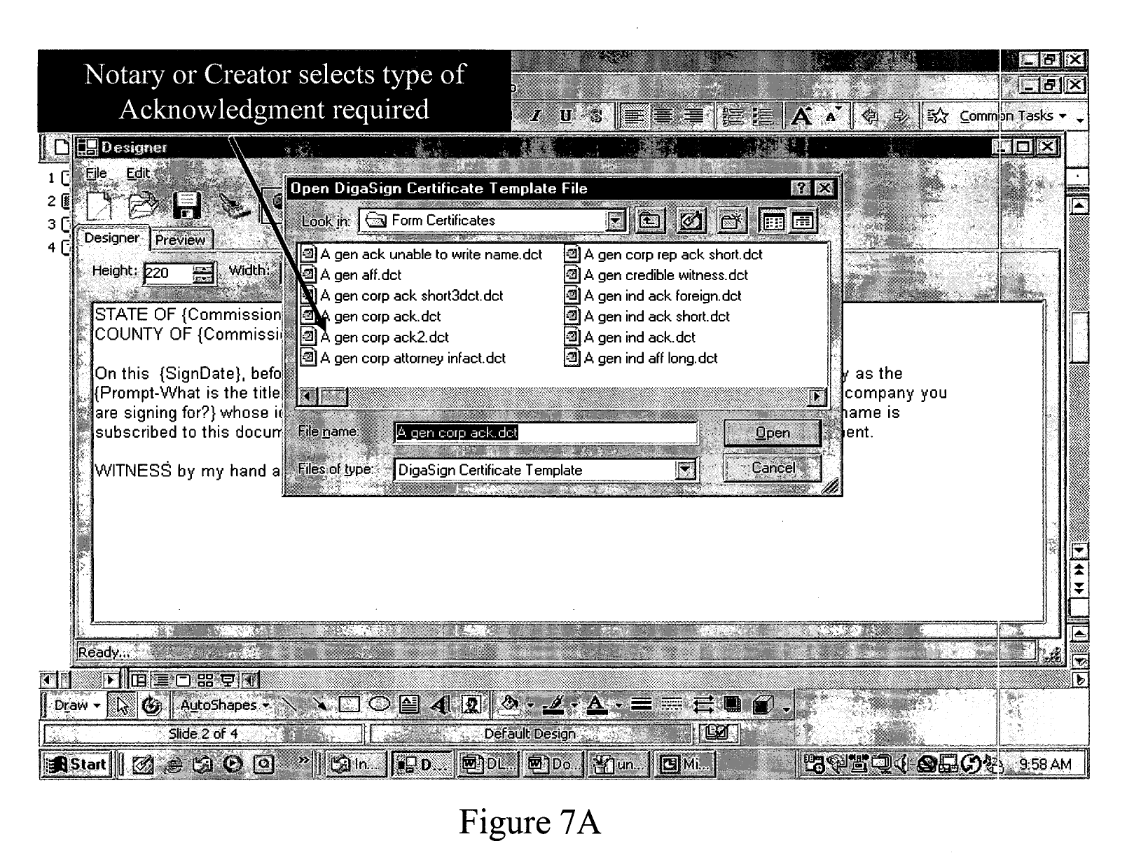

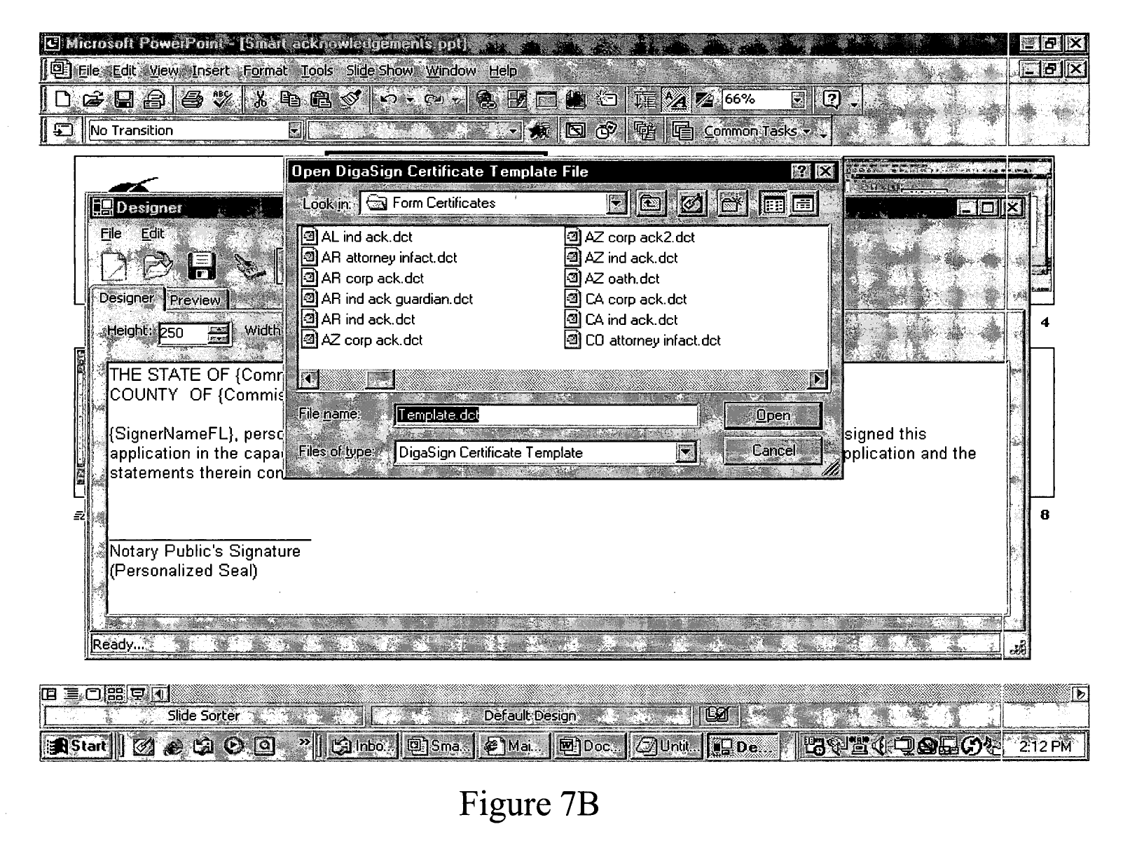

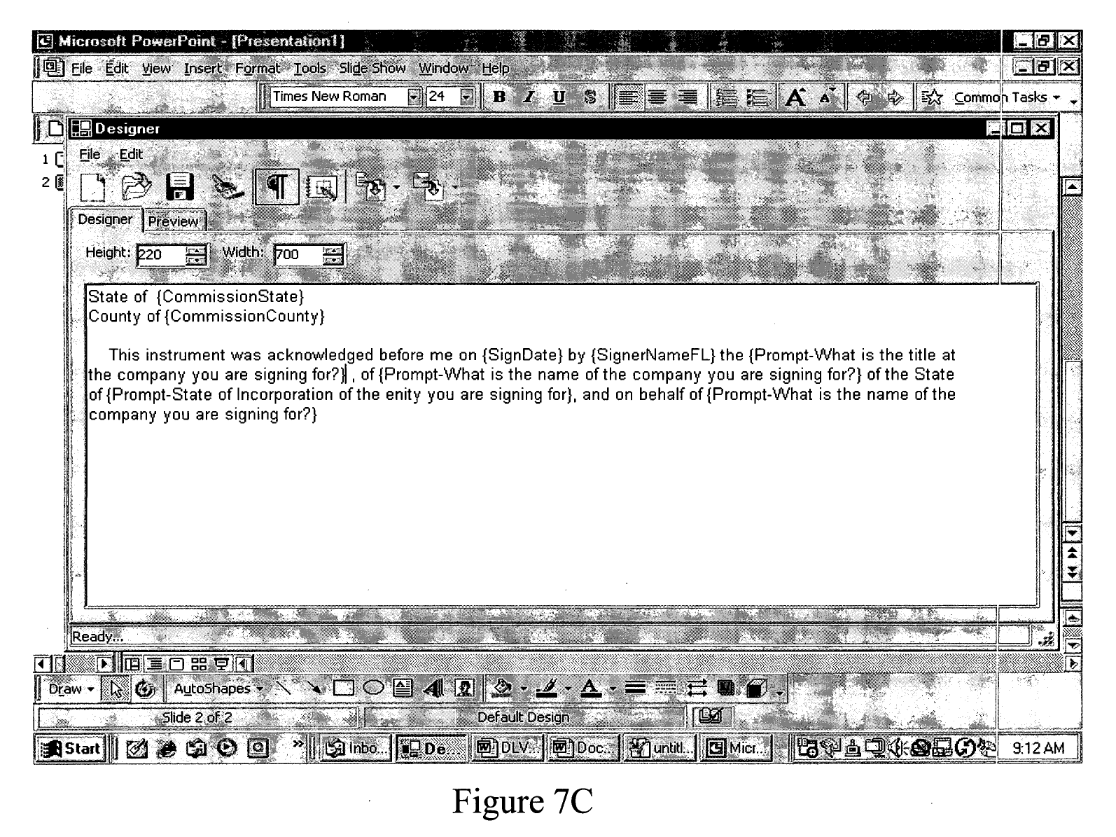

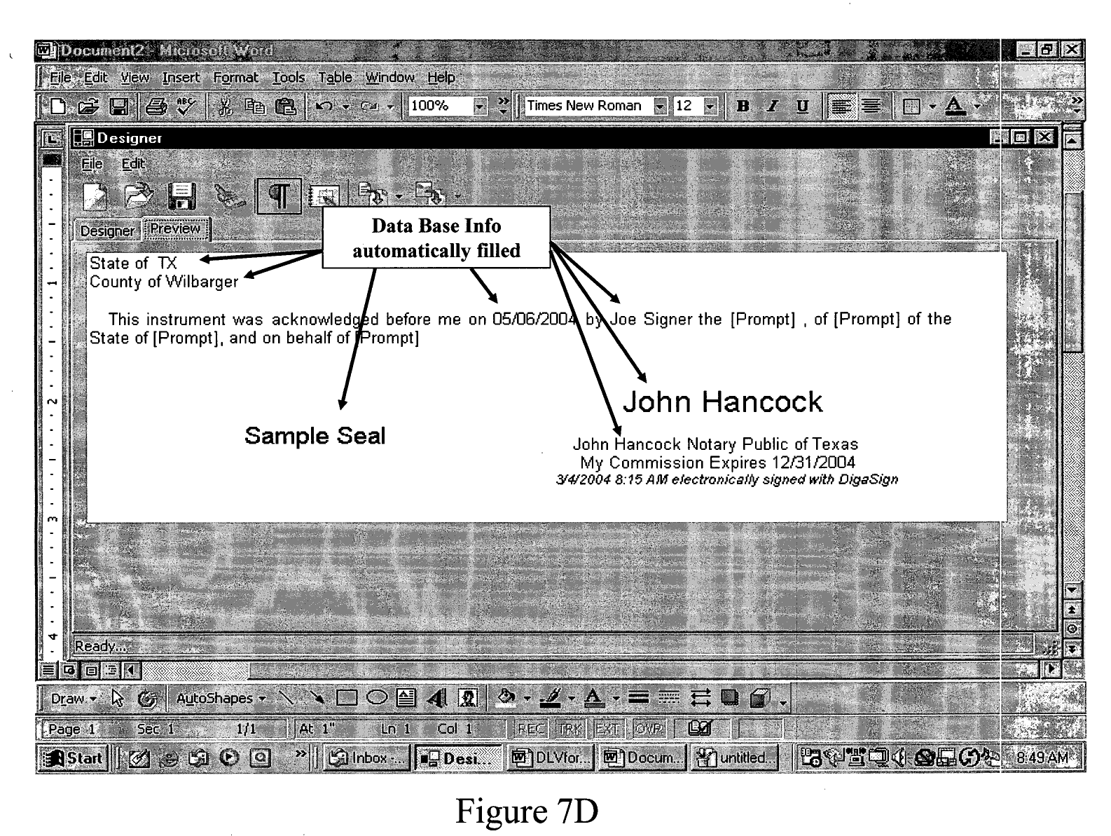

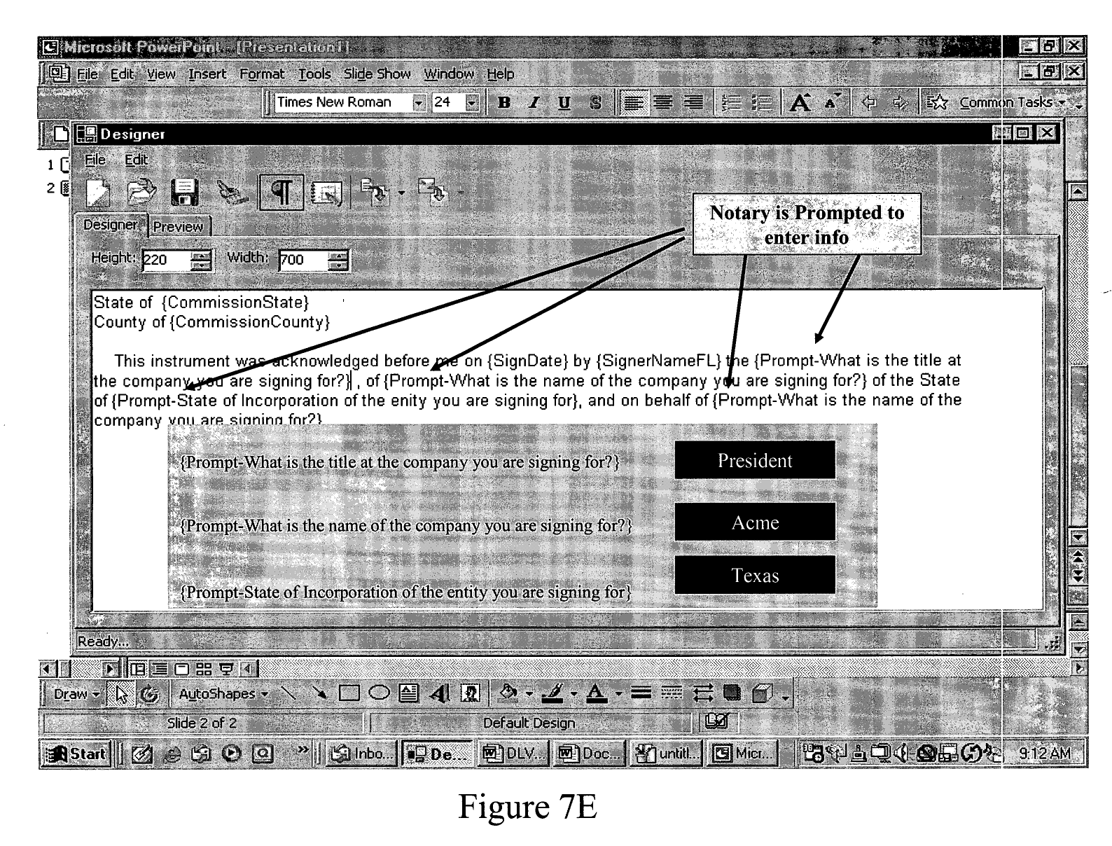

FIG. 7A shows a graphical user interface of a certificate template file in accordance with a preferred embodiment of the present invention. The file contains templates of notary certificates/acknowledgments that meet various legal requirements. These include various versions of corporate, individual, and attorney acknowledgments. The example acknowledgments shown in the template file in FIG. 7A are generic acknowledgments that are designed to comply with the majority of legal jurisdictions. The certificate templates themselves are written in extensible markup language (XML), allowing them to be easily inserted into the legal document in question. By selecting one of these templates, the creator can insert a notary certificate into a legal document automatically without having to write it from scratch and manually map the coordinates of the signatures and notary seal.

In addition to the generic acknowledgments, the template file also contains acknowledgments created for specific jurisdictions, as shown in FIG. 7B. While most jurisdictions require similar formalities for notary certificates, many jurisdictions also have their own idiosyncratic formalities that may not be covered by the generic templates. By providing pre-written templates that satisfy these various idiosyncratic formalities, the present invention significantly reduces the time and effort of creating legal documents and reduces the probability of a creator accidentally overlooking and omitting a necessary formality.

FIG. 7C shows a generic corporate acknowledgment that has been retrieved from the template file. As can be seen, several information fields such as Commission State, Signer Name, and Name of Company are contained in brackets. Those brackets that contain a Prompt require manual information input, whereas the brackets without a Prompt are filled automatically by the system (described below).

Returning to FIG. 6, when a notary in the network signs on and retrieves the document (step 602) the system can retrieve the notary's information from the data base and automatically fill it in on the certificate (step 603). The system can also fill in the signer's name based on the location of the notary (step 604). The date can be filled in based on the notary's computer calendar.

FIG. 7D shows the certificate with the data base information filled in. This information includes the state and county of the notary's commission, the notary's name and commission expiration, and the proper coordinates for the notary's seal. The name of the signer and date of signature are also filled in.

The last step in the process is to prompt the notary to manually enter information about the signer (step 605). As stated above, information fields that contain Prompts in the brackets are not filled in automatically. When the document is retrieved, the system provides an input field shown in FIG. 7E, which allows the notary to enter the correct information for each prompt. In the present example, the notary must enter the signer's position in the corporation, the name of the corporation, and the state of incorporation. After the prompted information is entered, the notary can complete the verification process as described above.

FIG. 7F shows a completed notary certification with the notary's seal and signature affixed.

The description of the present invention has been presented for purposes of illustration and description, and is not intended to be exhaustive or limited to the invention in the form disclosed. Many modifications and variations will be apparent to those of ordinary skill in the art. The embodiment was chosen and described in order to best explain the principles of the invention, the practical application, and to enable others of ordinary skill in the art to understand the invention for various embodiments with various modifications as are suited to the particular use contemplated.

We claim:

1. A method for verifying a document via a distributed computer network, the method comprising the steps of
(a) creating an electronic version of the document on a first client in the computer network;
(b) inserting a pre-written acknowledgment template into said electronic document, wherein the acknowledgment template complies with local legal formalities for a certified party that has authority by law to verify and authenticate the signer of a document;
(b) storing the electronic document on a server in the computer network;
(c) retrieving the electronic document on a second client in the computer network;
(d) electronically affixing at least one signing party's signature to the electronic document via the second client;
(e) electronically affixing a verifying party's signature to the electronic document via the second client, wherein the verifying party may be any certified party that has authority by law to verify and authenticate the signer of a document; and
(f) storing the signed, notarized, electronic document on said server.

2. The method according to claim 1, wherein step (c) further comprises automatically inserting information associated with the verifying party into the acknowledgment template.

3. The method according to claim 1, wherein step (c) further comprises automatically inserting the signing party's name into the acknowledgment template.

4. The method according to claim 1, wherein step (c) further comprises automatically inserting the date into the acknowledgment template.

5. The method according to claim 1, wherein step (c) further comprises prompting the verifying party to manually input specified information into the acknowledgment template.

6. A computer program product in a computer readable medium for verifying a document via a distributed computer network, the computer program product comprising:
(a) first instructions for creating an electronic version of the document on a first client in the computer network;
(b) second instructions for inserting a pre-written acknowledgment template into said electronic document, wherein the acknowledgment template complies with local legal formalities for a certified party that has authority by law to verify and authenticate the signer of a document;
(b) third instructions for storing the electronic document on a server in the computer network;
(c) fourth instructions for retrieving the electronic document on a second client in the computer network;
(d) fifth instructions for electronically affixing at least one signing party's signature to the electronic document via the second client;
(e) sixth instructions for electronically affixing a verifying party's signature to the electronic document via the second client, wherein the verifying party may be any certified party that has authority by law to verify and authenticate the signer of a document; and
(f) seventh instructions for storing the signed, notarized, electronic document on said server.

7. The method according to claim 6, wherein instructions (c) further comprise instructions for automatically inserting information associated with the verifying party into the acknowledgment template.

8. The method according to claim 6, wherein instructions (c) further comprise instructions for automatically inserting the signing party's name into the acknowledgment template.

9. The method according to claim 6, wherein instructions (c) further comprise instructions for automatically inserting the date into the acknowledgment template.

10. The method according to claim 6, wherein instructions (c) further comprise instructions for prompting the verifying party to manually input specified information into the acknowledgment template.

11. A system for verifying a document via a distributed computer network, the system comprising:
(a) a first input component for creating an electronic version of the document on a first client in the computer network;
(b) a component for inserting a pre-written acknowledgment template into said electronic document, wherein the acknowledgment template complies with local legal formalities for a certified party that has authority by law to verify and authenticate the signer of a document;
(b) a server in the computer network for storing the electronic document;
(c) a retrieval mechanism for retrieving the electronic document on a second client in the computer network;
(d) a second input component for electronically affixing at least one signing party's signature to the electronic document via the second client; and
(e) a third input component for electronically affixing a verifying party's signature to the electronic document via the second client, wherein the verifying party may be any certified party that has authority by law to verify and authenticate the signer of a document.

12. The system according to claim 11, wherein retrieval mechanism (c) further comprises means for automatically inserting information associated with the verifying party into the acknowledgment template.

13. The system according to claim 11, wherein retrieval mechanism (c) further comprises means for automatically inserting the signing party's name into the acknowledgment template.

14. The system according to claim 11, wherein retrieval mechanism (c) further comprises means for automatically inserting the date into the acknowledgment template.

15. The system according to claim 11, wherein retrieval mechanism (c) further comprises a prompter that prompts the verifying party to manually input specified information into the acknowledgment template.
